(19) United States
(12) Patent Application Publication
(10) Pub. No.: US 2025/0191580 A1
(43) Pub. Date: Jun. 12, 2025

(54) HEARING ASSISTANCE APPARATUS, HEARING ASSISTANCE METHOD, AND COMPUTER READABLE RECORDING MEDIUM

(71) Applicant: NEC Corporation, Minato-ku, Tokyo (JP)

(72) Inventors: Daichi NISHII, Tokyo (JP); Akira Gotoh, Tokyo (JP); Shuji Komeiji, Tokyo (JP); Yuko Nakanishi, Tokyo (JP); Yuka Enjoji, Tokyo (JP)

(73) Assignee: NEC Corporation, Minato-ku, Tokyo (JP)

(21) Appl. No.: 18/840,546

(22) PCT Filed: Mar. 16, 2022
(86) PCT No.: PCT/JP2022/011902

§ 371 Date: Aug. 22, 2024

(51) Int. Cl. G10L 15/18; G10L 15/22

(52) U.S. Cl. CPC G10L 15/18; G10L 15/22

(57) ABSTRACT

A hearing assistance apparatus including: a speech recognition information generating unit that executes speech recognition processing on first speech information to infer one or more words from the first speech information, and generates speech recognition information by, for each of the one or more inferred words, associating word information representing the inferred word with second speech information corresponding to the inferred word; and a speech output information generating unit that generates, using the second speech information corresponding to the one or more inferred words, speech output information for outputting, to a speech output device, second speech corresponding to the one or more inferred words.

### TECHNICAL FIELD

The technical field relates to a hearing assistance apparatus and a hearing assistance method for assisting hearing, and further relates to a computer readable recording medium having recorded thereon a program for implementing the same.

### BACKGROUND ART

A technology is known in which speech recognition processing is executed on input speech information, words are inferred from the speech information, candidates are presented for each inferred word, and a user makes selections from the presented words to form a sentence.

As a related technique, Patent Document 1 discloses a speech recognition apparatus that facilitates recognition and correction of a segment that has a recognition error in a speech recognition result. According to the speech recognition apparatus of Patent Document 1, first, input speech is divided into segments, speech recognition processing is executed on each of the segments to obtain words for each of the segments, and a speech recognition processing result consisting of the words is displayed.

Next, pending segments, which have been designated as pending among segments in the displayed speech recognition processing result, and segments not designated as pending are displayed by the speech recognition apparatus so as to be distinguishable from each other. Using this speech recognition apparatus makes it possible to extract a pending segment from the speech recognition processing result and edit a word or phrase in the extracted pending segment.

### LIST OF RELATED ART DOCUMENTS

### Patent Document

Patent Document 1: Japanese Patent Laid-Open Publication No. 2012-226220

### SUMMARY OF INVENTION

### Problems to be Solved by the Invention

However, if the user wishes to listen to a portion of the input speech again, with current technology, the user needs to manually search for the audio that corresponds to the desired portion.

Furthermore, the speech recognition apparatus of Patent Document 1 is not an apparatus that allows the user to listen to speech that corresponds to each of the inferred words.

One object of the present invention is to provide a hearing assistance apparatus, a hearing assistance method, and a computer readable recording medium that enable a speech output device to output speech that corresponds to one or more words displayed on a display device.

### Means for Solving the Problems

In order to achieve the example object described above, a hearing assistance apparatus according to an example aspect includes:
a speech recognition information generating unit that executes speech recognition processing on first speech information to infer one or more words from the first speech information, and generates speech recognition information by, for each of the one or more inferred words, associating word information representing the inferred word with second speech information corresponding to the inferred word; and
a speech output information generating unit that generates, using the second speech information corresponding to the one or more inferred words, speech output information for outputting, to a speech output device, second speech corresponding to the one or more inferred words.

Also, in order to achieve the example object described above, a hearing assistance method that is performed by a computer according to an example aspect includes:
executing speech recognition processing on first speech information to infer one or more words from the first speech information, and generating speech recognition information by, for each of the one or more inferred words, associating word information representing the inferred word with second speech information corresponding to the inferred word; and
generating, using the second speech information corresponding to the one or more inferred words, speech output information for outputting, to a speech output device, second speech corresponding to the one or more inferred words.

Furthermore, in order to achieve the example object described above, a computer-readable recording medium according to an example aspect includes a program recorded on the computer-readable recording medium, the program including instructions that cause the computer to carry out:
executing speech recognition processing on first speech information to infer one or more words from the first speech information, and generating speech recognition information by, for each of the one or more inferred words, associating word information representing the inferred word with second speech information corresponding to the inferred word; and
generating, using the second speech information corresponding to the one or more inferred words, speech output information for outputting, to a speech output device, second speech corresponding to the one or more inferred words.

### Advantageous Effects of the Invention

According to an aspect, it is possible to enable a speech output device to output speech that corresponds to one or more words displayed on a display device.

### BRIEF DESCRIPTION OF THE DRAWINGS

FIG. 1 is a diagram illustrating an example of a hearing assistance apparatus.

FIG. 2 is a diagram illustrating an example of a system that includes the hearing assistance apparatus according to the first example embodiment.

FIG. 3 is a diagram illustrating an example of the data structure of the speech recognition information.

FIG. 4 is a diagram for describing an example of the display of inferred words.

FIG. 5 is a diagram for describing an example of selection of an inferred word.

FIG. 6 is a diagram illustrating an example of operation of the hearing assistance apparatus.

FIG. 7 is a diagram illustrating an example of a system that includes the hearing assistance apparatus according to the second example embodiment.

FIG. 8 is diagrams for describing an example of a display in the second example embodiment.

FIGS. 9 is diagrams for describing an example of a display in the second example embodiment.

FIG. 10 is a diagram illustrating an example of operation of the hearing assistance apparatus.

FIG. 11 is a diagram for describing an example of a computer that realizes the hearing assistance apparatus in the first example embodiment and the second example embodiment.

### EXAMPLE EMBODIMENTS

Hereinafter, embodiments will be described with reference to the drawings. Note that in the drawings described below, elements having the same or corresponding functions are denoted by the same reference numerals, and repeated description thereof may be omitted.

### First Example Embodiment

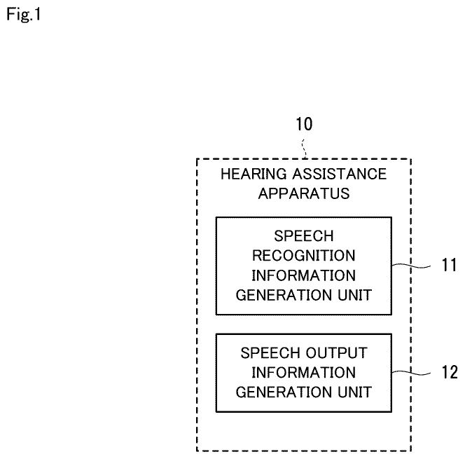

The configuration of a hearing assistance apparatus 10 according to a first example embodiment will be described below with reference to FIG. 1. FIG. 1 is a diagram illustrating an example of a hearing assistance apparatus.

### Apparatus Configuration

The hearing assistance apparatus 10 is an apparatus that, when a user selects one or more words (images representing words) displayed on a display device, generates speech output information for outputting speech that corresponds to the one or more selected words. The hearing assistance apparatus 10 includes a speech recognition information generation unit 11 and a speech output information generation unit 12.

The speech recognition information generation unit 11 executes speech recognition processing on first speech information to infer one or more words from the first speech information, and generates speech recognition information by, for each inferred word, associating word information representing the inferred word with second speech information corresponding to the inferred word.

The first speech information is information that represents an utterance (first speech) uttered by a person attending a conference, a person making a call using a communication device, or the like. The first speech information is information generated based on speech picked up using a microphone or the like. The first speech information may be speech waveform data, for example.

The second speech information is information representing speech (second speech) that corresponds to words inferred from the first speech information.

The speech recognition processing uses a technique such as ASR (Automatic Speech Recognition) to infer one or more words from speech information and generate word information that corresponds to the one or more inferred words.

The speech output information generation unit 12 uses the second speech information that corresponds to the inferred words to generate speech output information for outputting second speech that corresponds to the inferred words to a speech output device.

In this way, in the first example embodiment, by using speech recognition information (word information and second speech information) generated for each inferred word, it is possible to output corresponding speech for each word (image representing a word) displayed on a display device.

### System Configuration

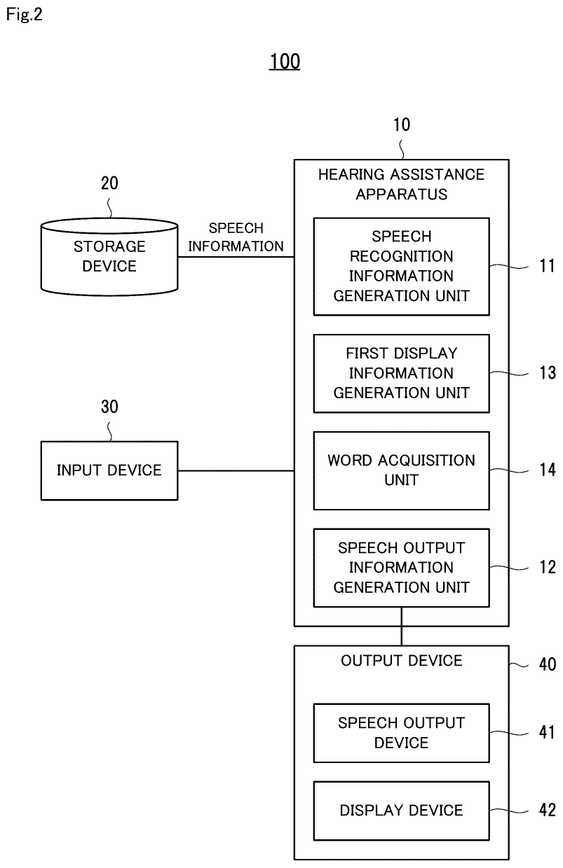

The configuration of the hearing assistance apparatus 10 in the first example embodiment will be described in more detail below with reference to FIG. 2. FIG. 2 is a diagram illustrating an example of a system that includes the hearing assistance apparatus according to the first example embodiment.

A system 100 includes at least a hearing assistance apparatus 10, a storage device 20, an input device 30, and an output device 40. The hearing assistance apparatus 10 includes at least a speech recognition information generation unit 11, a first display information generation unit 13, a word acquisition unit 14, and a speech output information generation unit 12. The output device 40 includes at least a speech output device 41 and a display device 42.

When a user uses the input device 30 to select one or more images representing words that correspond to words displayed on the display device 42, the hearing assistance apparatus 10 generates speech output information for outputting, to the speech output device 41, second speech corresponding to second speech information that corresponds to the selected words.

The hearing assistance apparatus 10 is an information processing device such as a CPU (Central Processing Unit), a programmable device (e.g., an FPGA (Field-Programmable Gate Array)), a GPU (Graphics Processing Unit), a circuit equipped with any one or more of the aforementioned, a server computer, a personal computer, or a mobile terminal, for example.

The storage device 20 is a device that stores at least speech information. The storage device 20 may be a database, a server computer, a circuit that has a memory, or the like.

In the example of FIG. 2, the storage device 20 is provided outside the hearing assistance apparatus 10, but it may also be provided inside the hearing assistance apparatus 10.

The input device 30 is a mouse, a keyboard, or a touch panel, for example. The input device 30 is used to, for example, operate the hearing assistance apparatus 10, the output device 40, or both.

The output device 40 includes a speech output device 41 that acquires speech output information and outputs speech, and a display device 42 that acquires display information and displays images, for example.

The speech output device 41 is a device that outputs speech, such as a speaker. The display device 42 is a device for displaying images, such as a liquid crystal display, an organic EL (Electro Luminescence) display, or a CRT (Cathode Ray Tube), for example. Note that the output device 40 may be a printing device such as a printer.

The hearing assistance apparatus will be described in detail below.

First, the speech recognition information generation unit 11 acquires first speech information stored (recorded) in the storage device 20. Alternatively, the speech recognition information generation unit 11 acquires, in real time, first speech information that corresponds to first speech input via a microphone or the like.

Next, the speech recognition information generation unit 11 executes speech recognition processing on the acquired first speech information, and infers one or more words from the first speech information.

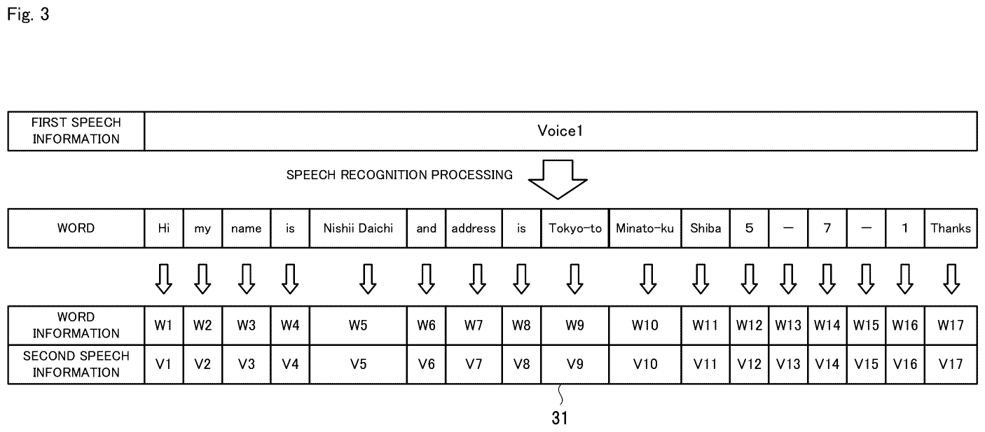

FIG. 3 is a diagram illustrating an example of the data structure of the speech recognition information. In the example of FIG. 3, first speech information Voicel is acquired, speech recognition processing is executed on the first speech information Voice1, and a plurality of words are inferred.

For example, in the case where the first speech is “Hi, my name is Nishii Daichi and address is Tokyo-to, Minato-ku, Shiba 5-7-1. Thanks.” which is uttered by the user, the words that are inferred from first speech information corresponding to that first speech are “Hi”, “my”, “name”, “is”, “Nishii Daichi”, “and”, “address”, “is”, “Tokyo-to”, “Minato-ku”, “Shiba”, “5”, “-”, “7”, “-”, “1”, and “Thanks”.

Next, the speech recognition information generation unit 11 generates speech recognition information by, for each inferred word, associating word information corresponding to the inferred word with speech information. Thereafter, the speech recognition information generation unit 11 stores the generated speech recognition information in the storage device 20, for example.

In the example of FIG. 3, the speech recognition information generation unit 11 generates speech recognition information 31 by, for each inferred word, associating a piece of word information (W1 to W17) corresponding to the inferred word with a piece of second speech information (V1 to V17). For example, in the case of the word “Hi”, word information “W1” that corresponds to the word “Hi” is associated with the second speech information “V1”.

First, using one or more pieces of word information, the first display information generation unit 13 generates display information for displaying images corresponding to the one or more words on the display device 42. Next, the first display information generation unit 13 outputs the generated display information to the display device 42.

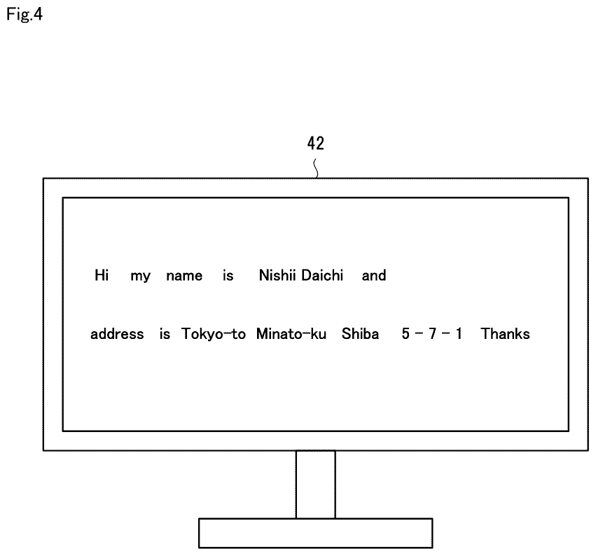

FIG. 4 is a diagram for describing an example of the display of inferred words. Using inferred words (“Hi”, “my”, “name”, “is”, “Nishii Daichi”, “and”, “address”, “is”, “Tokyo-to”, “Minato-ku”, “Shiba”, “5”, “-”, “7”, “-”, “1”, and “Thanks”), the first display information generation unit 13 generates display information for displaying “Hi, my name is Nishii Daichi and address is Tokyo-to, Minato-ku, Shiba 5-7-1. Thanks.” on the display device 42 as shown in FIG. 4.

When the user uses the input device 30 to select one or more images that correspond to one or more of words displayed on the display device 42, the word acquisition unit 14 acquires word information that corresponds to the one or more selected words.

Specifically, first, the user uses the input device 30 (e.g., a mouse) to select some or all of the images that correspond to the one or more words displayed on the display device 42. Next, the word acquisition unit 14 acquires word information that corresponds to the one or more selected words, or stores the acquired word information in the storage device 20 or the like.

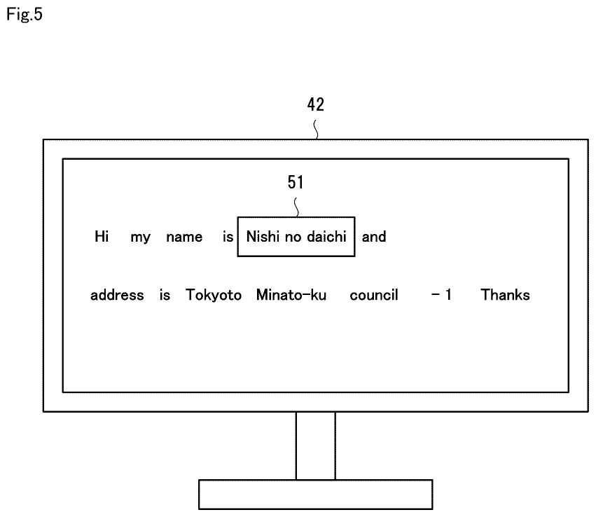

FIG. 5 is a diagram for describing an example of selection of an inferred word. FIG. 5 shows an example where words have not been inferred correctly. In the example of FIG. 5, the user selects “nishi”, “no”, and “daichi”, which have been determined to be words that were not inferred correctly.

Note that as shown in FIG. 5, the range of selected words may be displayed as a selection range 51 (solid outline). However, the display of the selection range is not limited to the example shown in FIG. 5. For example, the inside or the border of the selection range 51 may be colored.

The speech output information generation unit 12 uses the one or more pieces of selected word information to refer to the speech recognition information and acquire second speech information that corresponds to the one or more pieces of selected word information, and generates speech output information to be output to the speech output device 41, based on the acquired second speech information. Thereafter, the speech output information generation unit 12 outputs the generated speech output information to the speech output device 41.

In the example of FIG. 5, second speech information that corresponds to the selected words “nishi”, “no”, and “daichi” is acquired from the speech recognition information, and speech output information is generated based on the acquired second speech information. Next, the speech output information generation unit 12 outputs the generated speech output information to the speech output device 41. Thereafter, the speech output device 41 outputs speech that corresponds to the selected words “nishi”, “no”, and “daichi” based on the speech output information.

### Apparatus Operations in First Example Embodiment

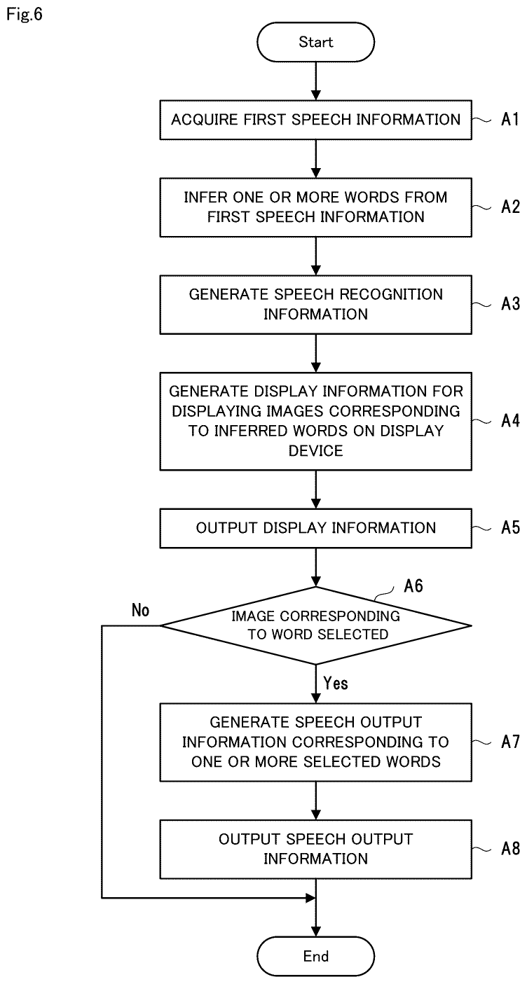

Operation of the hearing assistance apparatus according to the first example embodiment will be described below with reference to FIG. 6. FIG. 6 is a diagram illustrating an example of operation of the hearing assistance apparatus. The drawings will be referred to as appropriate in the following description. Also, in the first example embodiment, a hearing assistance method is carried out by causing the hearing assistance apparatus to operate. Therefore, the following description of operation of the hearing assistance apparatus will substitute for a description of the hearing assistance method according to the first example embodiment.

As shown in FIG. 6, first, the speech recognition information generation unit 11 acquires first speech information stored (recorded) in the storage device 20 (step A1). Alternatively, in step A1, the speech recognition information generation unit 11 acquires, in real time, first speech information that corresponds to speech input via a microphone or the like.

Next, the speech recognition information generation unit 11 executes speech recognition processing on the acquired first speech information, and infers one or more words from the first speech information (step A2).

Next, the speech recognition information generation unit 11 generates speech recognition information by, for each inferred word, associating word information corresponding to the inferred word with speech information (step A3). Thereafter, the speech recognition information generation unit 11 stores the generated speech recognition information in the storage device 20 or the like.

Using the one or more pieces of word information, the first display information generation unit 13 generates display information for displaying images that correspond to the one or more words on the display device 42 (step A4). Thereafter, the first display information generation unit 13 outputs the generated display information to the display device 42 (step A5).

If the user uses the input device 30 to select one or more images corresponding to one or more words displayed on the display device 42 (step A6: Yes), the word acquisition unit 14 stores the one or more pieces of selected word information in the storage device 20.

Note that if the user has not used the input device 30 to select any of the images corresponding to the words displayed on the display device 42 (step A6: No), the processing ends.

The speech output information generation unit 12 uses the one or more pieces of selected word information to refer to the speech recognition information and acquire second speech information corresponding to the one or more pieces of selected word information, and generates speech output information to be output to the speech output device 41, based on the acquired second speech information (step A7). Thereafter, the speech output information generation unit 12 outputs the generated speech output information to the speech output device 41 (step A8).

By executing the above-described processing of steps Al to A8, the user can listen to speech that corresponds to the selected words. Moreover, in order to listen to another portion, one or more of the words displayed on the display device 42 are selected again in step A6, and the processing of steps A7 and A8 is executed.

Furthermore, in order for the user to listen to new first speech information, the processing returns to step 1, and the processing of steps A1 to A8 is executed on the new first speech information.

### Effects of First Example Embodiment

According to the first example embodiment, by using speech recognition information (word information and speech information) generated for each inferred word, speech corresponding to images representing words displayed on the display device 42 can be freely listened to on a word-by-word basis.

Furthermore, conventionally, if a user was unable to hear a certain portion of speech, the user has needed to listen to the entirety of the speech again, but according to the first example embodiment, the user can simply select one or more words and instantly listen to the selected words, thus eliminating the need to listen to the entirety of the speech. Furthermore, the user does not need to be troubled to search for the portion of the speech that the user wishes to listen to.

Furthermore, the hearing assistance apparatus 10 can be used for tasks such as transcription for creating minutes of a meeting, and transcription based on speech, thereby making it possible to improve work efficiency. In other words, when performing the above-mentioned tasks, the user can select an incorrectly inferred word and listen to the selected word again in order to correctly recognize the word. Therefore, the user can efficiently correct the incorrect word.

Furthermore, the hearing assistance apparatus 10 can be used for calls at call centers, emergency calls (110, 119, etc.), air traffic control calls, and the like, to supplement the content of those calls, thus making it possible to improve business efficiency.

### Program of First Example Embodiment

The program according to the first example embodiment may be a program that causes a computer to execute steps A1 to A8 shown in FIG. 6. By installing this program in a computer and executing the program, the hearing assistance apparatus and the hearing assistance method according to the first example embodiment can be realized. In this case, the processor of the computer performs processing to function as the speech recognition information generation unit 11, the first display information generation unit 13, the word acquisition unit 14, and the speech output information generation unit 12.

Also, the program according to the first example embodiment may be executed by a computer system constructed by a plurality of computers. In this case, for example, each computer may function as any of the speech recognition information generation unit 11, the first display information generation unit 13, the word acquisition unit 14, and the speech output information generation unit 12.

### Second Example Embodiment

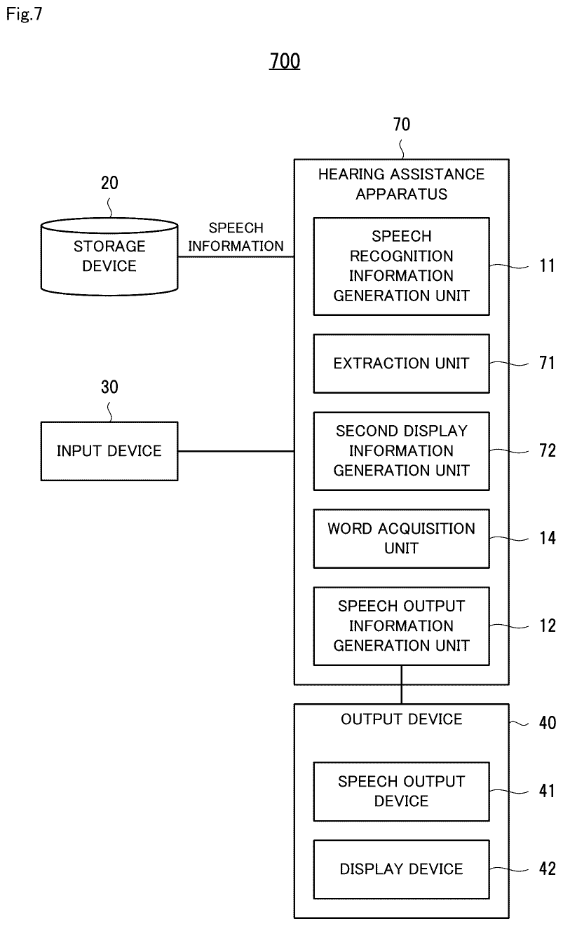

The configuration of a hearing assistance apparatus 70 according to a second example embodiment will be described in detail below with reference to FIG. 7. FIG. 7 is a diagram illustrating an example of a system that includes the hearing assistance apparatus according to the second example embodiment.

### System Configuration

A system 700 includes at least the hearing assistance apparatus 70, the storage device 20, the input device 30, and the output device 40 (speech output device 41, display device 42). The storage device 20, the input device 30, and the output device 40 have been described in the first example embodiment, and therefore descriptions will be omitted for the storage device 20, the input device 30, and the output device 40.

The hearing assistance apparatus 70 is an information processing device such as a CPU, a programmable device (e.g., an FPGA), a GPU, a circuit equipped with any one or more of the aforementioned, a server computer, a personal computer, or a mobile terminal, for example.

The hearing assistance apparatus 70 includes at least the speech recognition information generation unit 11, an extraction unit 71, a second display information generation unit 72, the word acquisition unit 14, and the speech output information generation unit 12. The speech recognition information generation unit 11 has been described in the first example embodiment, and thus a description thereof will be omitted.

The extraction unit 71 first executes text analysis processing on word information corresponding to a plurality of inferred words, and extracts one or more pieces of word information related to pre-set required information.

Conceivable examples of the required information include a name, an address, a telephone number, a social security number, a gender, a meeting time, a disease name, an illness name, and other information.

The text analysis processing is processing in which rule-based natural language processing or machine learning-based natural language processing such as morphological analysis or named entity extraction is used to extract required information from a sentence consisting of words based on the context of the words, for example.

Next, for each piece of required information, the extraction unit 71 generates extracted information in which title information indicating the title of the piece of required information is associated with one or more pieces of word information corresponding to the piece of required information. Thereafter, the extraction unit 71 stores the generated extracted information in the storage device 20, for example.

For example, when an emergency call is made to “110”, a police officer wishes to acquire required information such as the name and the address of the caller based on speech in the call. Therefore, “name”, “address”, and the like are set in advance as required information, and one or more words that correspond to such pieces of required information are extracted.

In the case where the inferred sentence consisting of a plurality of words is “Hi, my name is Nishii Daichi and address is Tokyo-to, Minato-ku, Shiba 5-7-1. Thanks.”, and the required information is “name” and “address”, the extraction unit 71 extracts, as the required information, “Nishii Daichi” which comes after “name” and “is”, and also extracts “Tokyo-to”, “Minato-ku”, “Shiba”, “5”, “-”, “7”, “-”, and “1” which come after “address” and “is”.

Also, in the case where the inferred sentence consisting of a plurality of words is “Hi, my name is nishi no daichi and address is Tokyo and Minato-ku, Kuyakusho, 1.”, and the required information is “name” and “address”, the extraction unit 71 extracts, as the required information, “nishi”, “no”, and “daichi” which come after “name” and “is”, and also extracts “Tokyo”, “and”, “Minato-ku”, “Kuyakusho”, and “1” which come after “address” and “is”.

The second display information generation unit 72 generates display information for causing the display device 42 to display title information corresponding to the required information and one or more pieces of word information corresponding to the required information. Next, the second display information generation unit 72 outputs the generated display information to the display device 42.

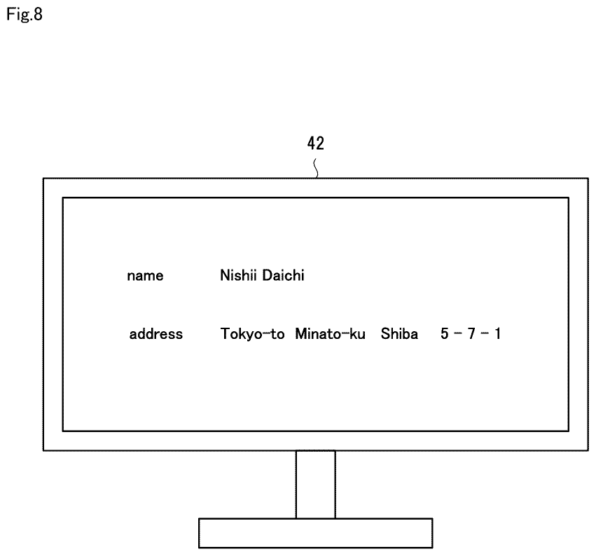

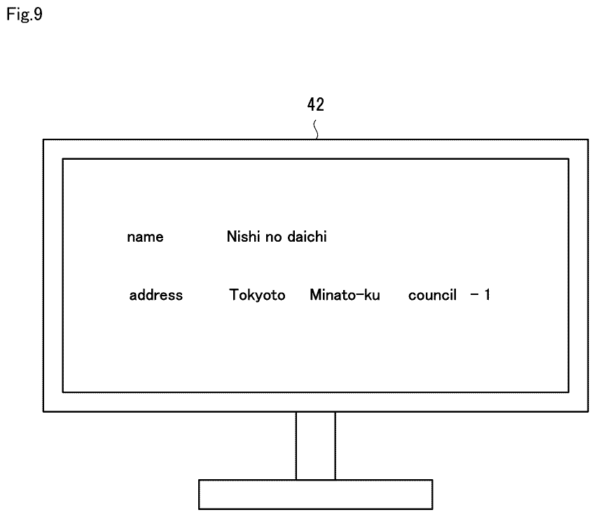

FIGS. 8 and 9 are diagrams for describing an example of a display in the second example embodiment. FIG. 8 shows an example of display information generated by the second display information generation unit 72 with use of the pieces of required information with the titles “name” and “address”, the word “Nishii Daichi” that corresponds to the title “name”, and the words “Tokyo-to”, “Minato-ku”, “Shiba”, “5”, “-”, “7”, “-”, and “1” that correspond to the title “address”.

FIG. 9 shows an example of display information generated by the second display information generation unit 72 with use of the pieces of required information with the titles “name” and “address”, the words “nishi”, “no”, and “daichi” that correspond to the title “name”, and the words “Tokyo”, “and”, “Minato-ku”, “Kuyakusho”, and “1” that correspond to the title “address”.

When the user uses the input device 30 to select one or more images corresponding to one or more words displayed on the display device 42, the word acquisition unit 14 stores word information corresponding to the one or more selected words.

Specifically, first, the user uses the input device 30 (e.g., a mouse) to select some or all of the images that correspond to the one or more words displayed on the display device 42. Next, the word acquisition unit 14 stores word information corresponding to the one or more selected words in the storage device 20 or the like.

In the example of FIG. 9, the user may select “nishi”, “no”, and “daichi”, which have been determined to be words that were not inferred correctly.

The speech output information generation unit 12 uses the one or more pieces of selected word information to refer to the speech recognition information and acquire second speech information that corresponds to the one or more pieces of selected word information, and generates speech output information to be output to the speech output device 41, based on the acquired second speech information. Thereafter, the speech output information generation unit 12 outputs the generated speech output information to the speech output device 41.

In the example of FIG. 9, second speech information that corresponds to the selected words “nishi”, “no”, and “daichi” is acquired from the speech recognition information, and speech output information is generated based on the acquired second speech information. Next, the speech output information generation unit 12 outputs the generated speech output information to the speech output device 41. Thereafter, the speech output device 41 outputs speech that corresponds to the selected words “nishi”, “no”, and “daichi” based on the speech output information.

### Apparatus Operations in Second Example Embodiment

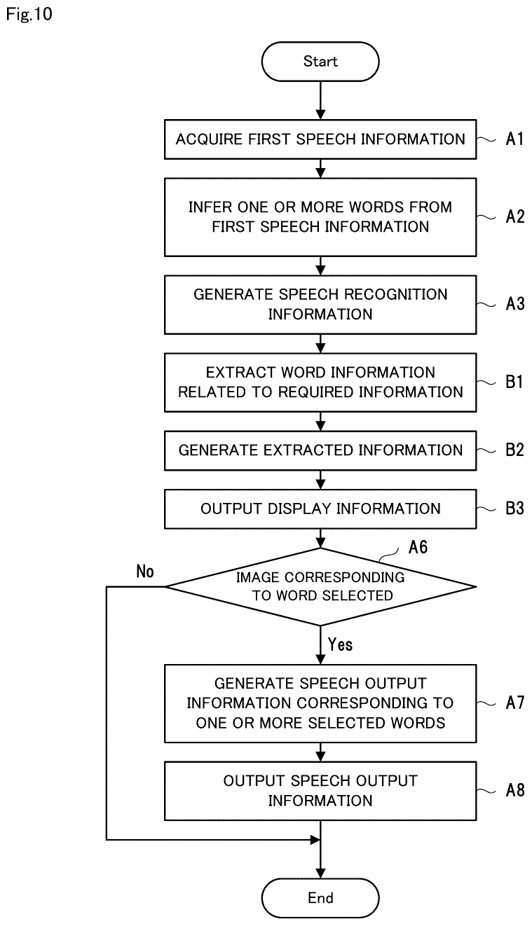

Next, operation of the hearing assistance apparatus according to the second example embodiment will be described below with reference to FIG. 10. FIG. 10 is a diagram illustrating an example of operation of the hearing assistance apparatus. The drawings will be referred to as appropriate in the following description. Also, in the second example embodiment, a hearing assistance method is carried out by causing the hearing assistance apparatus to operate. Therefore, the following description of operation of the hearing assistance apparatus will substitute for a description of the hearing assistance method according to the second example embodiment.

As shown in FIG. 10, first, the speech recognition information generation unit 11 acquires first speech information stored (recorded) in the storage device 20 (step A1). Alternatively, in step A1, the speech recognition information generation unit 11 acquires, in real time, first speech information that corresponds to speech input via a microphone or the like.

Next, the speech recognition information generation unit 11 executes speech recognition processing on the acquired first speech information, and infers one or more words from the first speech information (step A2).

Next, the speech recognition information generation unit 11 generates speech recognition information by, for each inferred word, associating word information corresponding to the inferred word with speech information (step A3). Thereafter, the speech recognition information generation unit 11 stores the generated speech recognition information in the storage device 20, for example.

Next, the extraction unit 71 executes text analysis processing on word information corresponding to the inferred words, and extracts word information related to pre-set required information (step B1).

Next, for each piece of required information, the extraction unit 71 generates extracted information in which title information indicating the title of the required information is associated with one or more pieces of word information corresponding to the required information (step B2). Thereafter, the extraction unit 71 stores the generated extracted information in the storage device 20, for example.

Next, the second display information generation unit 72 generates display information for displaying, on the display device 42, title information corresponding to the required information and one or more pieces of word information corresponding to the required information, and outputs the generated display information to the display device 42 (step B3).

If the user uses the input device 30 to select one or more images corresponding to one or more words displayed on the display device 42 (step A6: Yes), the word acquisition unit 14 stores the one or more pieces of selected word information in the storage device 20.

Note that if the user has not used the input device 30 to select any of the images corresponding to the words displayed on the display device 42 (step A6: No), the processing ends.

The speech output information generation unit 12 uses the one or more pieces of selected word information to refer to the speech recognition information and acquire second speech information corresponding to the one or more pieces of selected word information, and generates speech output information to be output to the speech output device 41, based on the acquired second speech information (step A7). Thereafter, the speech output information generation unit 12 outputs the generated speech output information to the speech output device 41 (step A8).

By executing the above-described steps A1 to A3, B1 to B3, and A6 to A8, the user can listen to speech that corresponds to the selected words. Moreover, in order to listen to another portion, one or more of the words displayed on the display device 42 are selected again in step A6, and the processing of steps A7 and A8 is executed.

Furthermore, in order for the user to listen to new first speech information, the processing returns to step 1, and the processing of steps A1 to A8 is executed on the new first speech information.

### Effects of Second Example Embodiment

According to the second example embodiment, by using speech recognition information (word information and speech information) generated for each inferred word, speech corresponding to images representing words displayed on the display device 42 can be freely listened to on a word-by-word basis.

Furthermore, conventionally, if a user was unable to hear a certain portion of speech, the user has needed to listen to the entirety of the speech again, but according to the second example embodiment, the user can simply select one or more words and instantly listen to the selected words, thus eliminating the need to listen to the entirety of the speech. Furthermore, the user does not need to be troubled to search for the portion of the speech that the user wishes to listen to.

Furthermore, the hearing assistance apparatus 70 can be used for tasks such as transcription for creating minutes of a meeting, and transcription based on speech, thereby making it possible to improve work efficiency. In other words, when performing the above-mentioned tasks, the user can select an incorrectly inferred word and listen to the selected word again in order to correctly recognize the word. Therefore, the user can efficiently correct the incorrect word.

Furthermore, the hearing assistance apparatus 70 can be used for calls at call centers, emergency calls (110, 119, etc.), air traffic control calls, and the like, to supplement the content of those calls, thus making it possible to improve business efficiency.

### Program

The program according to the second example embodiment may be a program that causes a computer to execute steps A1 to A3, B1 to B3 and A6 to A8 shown in FIG. 10. By installing this program in a computer and executing the program, the hearing assistance apparatus and the hearing assistance method according to the second example embodiment can be realized. In this case, the processor of the computer performs processing to function as the speech recognition information generation unit 11, the second display information generation unit 72, the word acquisition unit 14, and the speech output information generation unit 12.

Also, the program according to the second example embodiment may be executed by a computer system constructed by a plurality of computers. In this case, for example, each computer may function as any of the speech recognition information generation unit 11, the second display information generation unit 72, the word acquisition unit 14, and the speech output information generation unit 12.

### Physical Configuration

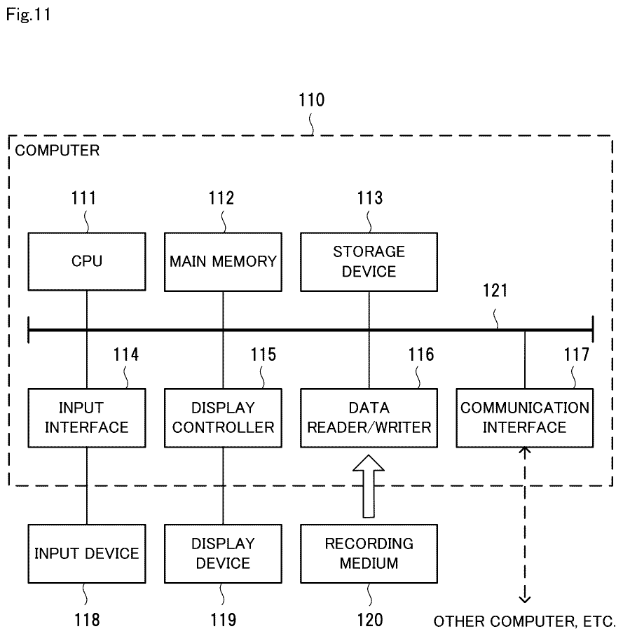

Here, a computer that realizes a hearing assistance apparatus by executing the program according to the first or second example embodiment will be described below with reference to FIG. 11. FIG. 11 is a diagram illustrating an example of a computer that realizes the hearing assistance apparatus according to the first or second example embodiment.

As shown in FIG. 11, a computer 110 includes a CPU (Central Processing Unit) 111, a main memory 112, a storage device 113, an input interface 114, a display controller 115, a data reader/writer 116, and a communication interface 117. These units are connected to each other via a bus 121 so as to be able to perform data communication with each other. Note that the computer 110 may include a GPU or an FPGA in addition to the CPU 111, or instead of the CPU 111.

The CPU 111 loads the program (code) according to the first or second example embodiment, which is stored in the storage device 113, into the main memory 112 and executes the processing steps in a predetermined order to perform various computation. The main memory 112 is typically a volatile storage device such as a DRAM (Dynamic Random Access Memory). Moreover, the program of the first or second example embodiment is provided in a state of being stored on a computer readable recording medium 120. The program of the first or second example embodiment may be distributed over the Internet, to which a connection is made via the communication interface 117. The recording medium 120 is a non-volatile recording medium.

Specific examples of the storage device 113 include a hard disk drive and a semiconductor storage device such as a flash memory. The input interface 114 mediates the transmission of data between the CPU 111 and the input device 118, which is a keyboard, a mouse, or the like. The display controller 115 is connected to the display device 119 and controls the display on the display device 119.

The data reader/writer 116 mediates the transmission of data between the CPU 111 and the recording medium 120, reads out a program from the recording medium 120, and writes the results of processing performed by the computer 110 to the recording medium 120. The communication interface 117 mediates the transmission of data between the CPU 111 and another computer.

Specific examples of the recording medium 120 include general-purpose semiconductor storage devices such as CF (Compact Flash (registered trademark)) and SD (Secure Digital), magnetic recording media such as a flexible disk, and optical recording media such as a CD-ROM (Compact Disk Read Only Memory).

A hearing assistance apparatus according to the first or second example embodiment can also be realized by using hardware corresponding to the units, rather than a computer in which a program is installed. Furthermore, a configuration is possible in which a portion of the hearing assistance apparatus is realized by a program, and the remaining portion is realized by hardware.

### SUPPLEMENTARY NOTES

Furthermore, the following supplementary notes are disclosed regarding the example embodiments described above. Some portion or all of the example embodiments described above can be realized according to (Supplementary Note 1) to (Supplementary Note 12) described below, but the below description does not limit the present invention.

### (Supplementary Note 1)

A hearing assistance apparatus comprising:
a speech recognition information generating unit that executes speech recognition processing on first speech information to infer one or more words from the first speech information, and generates speech recognition information by, for each of the one or more inferred words, associating word information representing the inferred word with second speech information corresponding to the inferred word; and
a speech output information generating unit that generates, using the second speech information corresponding to the one or more inferred words, speech output information for outputting, to a speech output device, second speech corresponding to the one or more inferred words.

### (Supplementary Note 2)

The hearing assistance apparatus according to claim 1, further comprising:
a first display information generating unit that generates, using the word information, display information for displaying one or more images corresponding to the one or more inferred words on a display device; and
a word acquiring unit that acquires, in a case where an input device is used by a user to select one or more images among the one or more images corresponding to the one or more inferred words and displayed by the display device, one or more pieces of word information corresponding to the one or more selected words,
wherein the speech output information generating unit refers to the speech recognition information using the one or more selected pieces of word information, acquires the second speech information corresponding to the one or more selected pieces of the word information, and generates speech output information to be output to the speech output device, based on the acquired second speech information.

### (Supplementary Note 3)

The hearing assistance apparatus according to claim 1, further comprising:
an extracting unit that executes text analysis processing on the word information corresponding to the one or more inferred words, and extracting one or more pieces of the word information related to pre-set required information; and
a second display information generating unit that generates display information for causing a display device to display title information indicating a title of the required information and the one or more pieces of the word information related to the required information.

### (Supplementary Note 4)

The hearing assistance apparatus according to claim 3, further comprising:
a word acquiring unit that acquires, in a case where an input device is used by a user to select one or more images among the one or more images corresponding to the one or more inferred words and displayed by the display device, one or more pieces of word information corresponding to the one or more selected words,
wherein the speech output information generating unit refers to the speech recognition information using the one or more selected pieces of word information, acquires the second speech information corresponding to the one or more selected pieces of the word information, and generates speech output information to be output to the output device, based on the acquired second speech information.

### (Supplementary Note 5)

A hearing assistance method comprising causing a computer to carry out the steps of:
a speech recognition information generating step of, executing speech recognition processing on first speech information to infer one or more words from the first speech information, and generating speech recognition information by, for each of the one or more inferred words, associating word information representing the inferred word with second speech information corresponding to the inferred word; and
a speech output information generating step of generating, using the second speech information corresponding to the one or more inferred words, speech output information for outputting, to a speech output device, second speech corresponding to the one or more inferred words.

### (Supplementary Note 6)

The hearing assistance method according to claim 5, further comprising causing the computer to carry out the steps of:
a first display information generating step of generating, using the word information, display information for displaying one or more images corresponding to the one or more inferred words on a display device;
a selecting step of acquiring, in a case where an input device is used by a user to select one or more images among the one or more images corresponding to the one or more inferred words and displayed by the display device, one or more pieces of word information corresponding to the one or more selected words; and
wherein the speech output information generating step of, referring to the speech recognition information using the one or more selected pieces of word information, acquiring the second speech information corresponding to the one or more selected pieces of the word information, and generating speech output information to be output to the speech output device, based on the acquired second speech information.

### (Supplementary Note 7)

The hearing assistance method according to claim 5, further comprising causing the computer to carry out the steps of:
an extracting step of executing text analysis processing on the word information corresponding to the one or more inferred words, and extracting one or more pieces of the word information related to pre-set required information; and
a second display information generating step of generating display information for causing a display device to display title information indicating a title of the required information and the one or more pieces of the word information related to the required information.

### (Supplementary Note 8)

The hearing assistance method according to claim 7, further comprising causing the computer to carry out the steps of:
a selecting step of acquiring, in a case where an input device is used by a user to select one or more images among the one or more images corresponding to the one or more inferred words and displayed by the display device, one or more pieces of word information corresponding to the one or more selected words; and
wherein the speech output information generating step, referring to the speech recognition information using the one or more selected pieces of word information, acquiring the second speech information corresponding to the one or more selected pieces of the word information, and generating speech output information to be output to the speech output device, based on the acquired second speech information.

### (Supplementary Note 9)

A computer readable recording medium that includes a program recorded thereon, the program including instructions that causes a computer to carry out the steps of:
a speech recognition information generating step of, executing speech recognition processing on first speech information to infer one or more words from the first speech information, and generating speech recognition information by, for each of the one or more inferred words, associating word information representing the inferred word with second speech information corresponding to the inferred word; and
a speech output information generating step of generating, using the second speech information corresponding to the one or more inferred words, speech output information for outputting, to a speech output device, second speech corresponding to the one or more inferred words.

### (Supplementary Note 10)

The computer readable recording medium according to claim 9, the program further including instructions that causes a computer to carry out the steps of:
a first display information generating step of generating, using the word information, display information for displaying one or more images corresponding to the one or more inferred words on a display device;
a selecting step of acquiring, in a case where an input device is used by a user to select one or more images among the one or more images corresponding to the one or more inferred words and displayed by the display device, one or more pieces of word information corresponding to the one or more selected words; and
wherein the speech output information generating step of, referring to the speech recognition information using the one or more selected pieces of word information, acquiring the second speech information corresponding to the one or more selected pieces of the word information, and generating speech output information to be output to the speech output device, based on the acquired second speech information.

### (Supplementary Note 11)

The computer readable recording medium according to claim 9, the program further including instructions that causes a computer to carry out the steps of:
an extracting step of executing text analysis processing on the word information corresponding to the one or more inferred words, and extracting one or more pieces of the word information related to pre-set required information; and
a second display information generating step of generating display information for causing a display device to display title information indicating a title of the required information and the one or more pieces of the word information related to the required information.

### (Supplementary Note 12)

The computer readable recording medium according to claim 11, the program further including instructions that causes a computer to carry out the steps of:
a selecting step of acquiring, in a case where an input device is used by a user to select one or more images among the one or more images corresponding to the one or more inferred words and displayed by the display device, one or more pieces of word information corresponding to the one or more selected words; and
wherein the speech output information generating step, referring to the speech recognition information using the one or more selected pieces of word information, acquiring the second speech information corresponding to the one or more selected pieces of the word information, and generating speech output information to be output to the speech output device, based on the acquired second speech information.

Although the present invention of this application has been described with reference to exemplary embodiments, the present invention of this application is not limited to the above exemplary embodiments. Within the scope of the present invention of this application, various changes that can be understood by those skilled in the art can be made to the configuration and details of the present invention of this application.

### INDUSTRIAL APPLICABILITY

According to the above description, it is possible to enable the speech output device to output speech that corresponds to one or more words displayed on the display device. The present invention is also useful in the field of listening to one or more words generated from speech.

### LIST OF REFERENCE SIGNS

10 Hearing assistance apparatus
11 Speech recognition information generation unit
12 Speech output information generation unit
13 First display information generation unit
14 Word acquisition unit
20 Storage device
30 Input device
40 Output device
41 Speech output device
42 Display device
71 Extraction unit
72 Second display information generation unit
100 and 700 System
110 Computer
111 CPU
112 Main memory
113 Storage device
114 Input interface
115 Display controller
116 Data reader/writer
117 Communication interface
118 Input device
119 Display device
120 Recording medium
121 Bus

What is claimed is:

1. A hearing assistance apparatus comprising:
at least one memory storing instructions; and
at least one processor configured to execute the instructions to:
execute speech recognition processing on first speech information to infer one or more words from the first speech information, and generate speech recognition information by, for each of the one or more inferred words, associating word information representing the inferred word with second speech information corresponding to the inferred word; and
generate, using the second speech information corresponding to the one or more inferred words, speech output information for outputting, to a speech output device, second speech corresponding to the one or more inferred words.

2. The hearing assistance apparatus according to claim 1, wherein the one or more processors further:
generates, using the word information, display information for displaying one or more images corresponding to the one or more inferred words on a display device; and
acquires, in a case where an input device is used by a user to select one or more images among the one or more images corresponding to the one or more inferred words and displayed by the display device, one or more pieces of word information corresponding to the one or more selected words,
refers to the speech recognition information using the one or more selected pieces of word information, acquires the second speech information corresponding to the one or more selected pieces of the word information, and generates speech output information to be output to the speech output device, based on the acquired second speech information.

3. The hearing assistance apparatus according to claim 1,
wherein the one or more processors further:
executes text analysis processing on the word information corresponding to the one or more inferred words, and extracting one or more pieces of the word information related to pre-set required information; and
generates display information for causing a display device to display title information indicating a title of the required information and the one or more pieces of the word information related to the required information.

4. The hearing assistance apparatus according to claim 3,
wherein the one or more processors further:
acquires, in a case where an input device is used by a user to select one or more images among the one or more images corresponding to the one or more inferred words and displayed by the display device, one or more pieces of word information corresponding to the one or more selected words,
refers to the speech recognition information using the one or more selected pieces of word information, acquires the second speech information corresponding to the one or more selected pieces of the word information, and generates speech output information to be output to the output device, based on the acquired second speech information.

5. A hearing assistance method comprising causing a computer to carry out the steps of:
executing speech recognition processing on first speech information to infer one or more words from the first speech information, and generating speech recognition information by, for each of the one or more inferred words, associating word information representing the inferred word with second speech information corresponding to the inferred word; and
generating, using the second speech information corresponding to the one or more inferred words, speech output information for outputting, to a speech output device, second speech corresponding to the one or more inferred words.

6. The hearing assistance method according to claim 5, further comprising causing the computer to carry out the steps of:
generating, using the word information, display information for displaying one or more images corresponding to the one or more inferred words on a display device;
acquiring, in a case where an input device is used by a user to select one or more images among the one or more images corresponding to the one or more inferred words and displayed by the display device, one or more pieces of word information corresponding to the one or more selected words; and
referring to the speech recognition information using the one or more selected pieces of word information, acquiring the second speech information corresponding to the one or more selected pieces of the word information, and generating speech output information to be output to the speech output device, based on the acquired second speech information.

7. The hearing assistance method according to claim 5, further comprising causing the computer to carry out the steps of:
executing text analysis processing on the word information corresponding to the one or more inferred words, and extracting one or more pieces of the word information related to pre-set required information; and
generating display information for causing a display device to display title information indicating a title of the required information and the one or more pieces of the word information related to the required information.

8. The hearing assistance method according to claim 7, further comprising causing the computer to carry out the steps of:
acquiring, in a case where an input device is used by a user to select one or more images among the one or more images corresponding to the one or more inferred words and displayed by the display device, one or more pieces of word information corresponding to the one or more selected words; and
referring to the speech recognition information using the one or more selected pieces of word information, acquiring the second speech information corresponding to the one or more selected pieces of the word information, and generating speech output information to be output to the speech output device, based on the acquired second speech information.

9. A non-transitory computer readable recording medium that includes a program recorded thereon, the program including instructions that causes a computer to carry out the steps of:
executing speech recognition processing on first speech information to infer one or more words from the first speech information, and generating speech recognition information by, for each of the one or more inferred words, associating word information representing the inferred word with second speech information corresponding to the inferred word; and
generating, using the second speech information corresponding to the one or more inferred words, speech output information for outputting, to a speech output device, second speech corresponding to the one or more inferred words.

10. The non-transitory_computer readable recording medium according to claim 9, the program further including instructions that causes a computer to carry out the steps of:
generating, using the word information, display information for displaying one or more images corresponding to the one or more inferred words on a display device;
acquiring, in a case where an input device is used by a user to select one or more images among the one or more images corresponding to the one or more inferred words and displayed by the display device, one or more pieces of word information corresponding to the one or more selected words; and
referring to the speech recognition information using the one or more selected pieces of word information, acquiring the second speech information corresponding to the one or more selected pieces of the word information, and generating speech output information to be output to the speech output device, based on the acquired second speech information.

11. The non-transitory_computer readable recording medium according to claim 9, the program further including instructions that causes a computer to carry out the steps of:
executing text analysis processing on the word information corresponding to the one or more inferred words, and extracting one or more pieces of the word information related to pre-set required information; and
generating display information for causing a display device to display title information indicating a title of the required information and the one or more pieces of the word information related to the required information.

12. The non-transitory_computer readable recording medium according to claim 11, the program further including instructions that causes a computer to carry out the steps of:
acquiring, in a case where an input device is used by a user to select one or more images among the one or more images corresponding to the one or more inferred words and displayed by the display device, one or more pieces of word information corresponding to the one or more selected words; and
referring to the speech recognition information using the one or more selected pieces of word information, acquiring the second speech information corresponding to the one or more selected pieces of the word information, and generating speech output information to be output to the speech output device, based on the acquired second speech information.
